(19) United States
(12) Patent Application Publication
(10) Pub. No.: US 2024/0414678 A1
(43) Pub. Date: Dec. 12, 2024

(54) METHOD AND APPARATUS FOR CONTROLLING NON-ULTRA WIDE BAND APPARATUS BY USING ULTRA WIDE BAND COMMUNICATION

(71) Applicant: Samsung Electronics Co., Ltd., Suwon-si, Gyeonggi-do (KR)

(72) Inventors: Junyoung CHOI, Suwon-si (KR); Mingyu LEE, Suwon-si (KR)

(21) Appl. No.: 18/697,361

(22) PCT Filed: Oct. 1, 2021
(86) PCT No.: PCT/KR2021/013520

§ 371 Date: Mar. 29, 2024

(51) Int. Cl. H04W 60/04; H04B 1/7163; H04W 64/00

(52) U.S. Cl. CPC H04W 60/04; H04B 1/7163; H04W 64/00

(57) ABSTRACT

The present disclosure provides a method for controlling a non-UWB apparatus by using a UWB. A method of a first UWB apparatus, of the present disclosure, may comprise the steps of: registering a non-UWB apparatus on the basis of a UWB ranging between the first UWB apparatus and a second UWB apparatus; and recognizing the registered non-UWB apparatus on the basis of a pointing direction of the first UWB apparatus.

### CROSS-REFERENCE TO RELATED APPLICATION(S)

This application is a U.S. National Stage application under 35 U.S.C. § 371 of an International application number PCT/KR2021/013520, filed on Oct. 1, 2021, in the Korean Intellectual Property Office, the disclosure of which is incorporated by reference herein in its entirety.

### TECHNICAL FIELD

The disclosure relates to UWB communication and, more particularly, to a method and an apparatus for controlling a non-UWB device using a UWB.

### BACKGROUND ART

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

As various services can be provided according to the development of wireless communication systems, a method of effectively providing the services is needed. For example, a ranging technology for measuring the distance between electronic devices using ultra-wideband (UWB) may be used. UWB is a wireless communication technology using a very wide frequency band higher than or equal to several GHz in a baseband without the use of a radio carrier.

### DETAILED DESCRIPTION OF THE INVENTION

### Technical Problem

The disclosure provides a method of identifying, through UWB ranging between UWB devices, a location of a non-UWB device which does not support UWB ranging. Further, the disclosure provides a method of recognizing and controlling, through a UWB device, the non-UWB device of which the location has been identified using the UWB ranging between UWB devices.

### Technical Solution

A method by a first UWB device according to various embodiments of the disclosure includes registering a non-UWB device, based on UWB ranging between the first UWB device and a second UWB device and recognizing the registered non-UWB device, based on a direction to which the first UWB device points.

As an embodiment, the registering of the non-UWB device may include identifying a location of the first UWB device relative to the second UWB device, based on the UWB ranging between the first UWB device and the second UWB device, and a result of the UWB ranging may include time of flight (ToF) information and angle of arrival (AoA) information.

As an embodiment, the registering of the non-UWB device may further include acquiring slope information of the first UWB device pointing to at least two points of the non-UWB device within a preset distance and identifying a location of the non-UWB device and an area corresponding to the non-UWB device relative to a location of the second UWB device, based on the location of the first UWB device, the AoA information, the preset distance, and the slop information.

As an embodiment, the registering of the non-UWB device may further include identifying a first location of the first UWB device relative to the location of the second UWB device by using a result of first UWB ranging with the second UWB device at the first location and identifying a second location of the first UWB device relative to the location of the second UWB device by using a result of second UWB ranging with the second UWB device at the second location, and the result of the first UWB ranging may include first ToF information and first AoA information for the first location, and the result of the second UWB ranging includes second ToF information and second AoA information for the second location.

As an embodiment, the registering of the non-UWB device may further include acquiring first angle information and first distance information related to the first UWB device pointing to at least two points of the non-UWB device at the first location and acquiring second angel information and second distance information related to the first UWB device pointing to at least two points of the non-UWB device at the second location, the first angle information may include first horizontal angle information for a horizontal angle between a first point and a second point of the non-UWB device to which the first UWB device at the first location points and first vertical angle information for a vertical angle between the first point and a third point of the non-UWB device to which the first UWB device at the first location points, and the second angle information may include second horizontal angle information for a horizontal angle between the first point and the second point of the non-UWB device to which the first UWB device at the second location points.

As an embodiment, the registering of the non-UWB device may further include identifying a location of the first point of the non-UWB device relative to the location of the second UWB device by acquiring an intersection point on an xy plane between a first straight line pointing to the first point of the non-UWB device at the first location and a second straight line pointing to the first point of the non-UWB device at the second location, based on at least one piece of the first horizontal angle information, the first distance information, the second horizontal angle information, or the second distance information, identifying a location of the second point of the non-UWB device relative to the location of the second UWB device by acquiring an intersection point on an xy plane between a third straight line pointing to the second point of the non-UWB device at the first location and a fourth straight line pointing to the second point of the non-UWB device at the second location, based on at least one piece of the first angle information, the first distance information, the second angle information, or the second distance information, and identifying a location of the third point of the non-UWB device relative to the location of the second UWB device, based on the first vertical angle information.

As an embodiment, the registering of the non-UWB device may further include identifying the area corresponding to the non-UWB device, based on the locations of the first point, the second point, and the third point.

As an embodiment, the UWB ranging may be performed based on a two-way ranging (TWR) method.

A first UWB device according to various embodiments of the disclosure includes a transceiver and a controller connected to the transceiver, the controller may be configured to register a non-UWB device, based on UWB ranging between the first UWB device and a second UWB device and recognize the registered non-UWB device, based on a direction to which the first UWB device points.

### Advantageous Effects

According to the method of the disclosure, it is possible to identify a location of a non-UWB device which does not support UWB ranging. Further, according to the method of the disclosure, it is possible to recognize and control the non-UWB device by using a UWB device.

### BRIEF DESCRIPTION OF DRAWINGS

FIG. 1 is a block diagram schematically illustrating an electronic device.

FIG. 2A illustrates an example of architecture of a UWB device.

FIG. 2B illustrates an example of a configuration of the framework of the UWB device.

FIG. 3 illustrates an example of a configuration of a communication system including the UWB device.

FIG. 4 illustrates a UWB ranging operation between UWB devices.

FIG. 5 illustrates a method by which a UWB-enabled device controls a UWB-disabled device according to an embodiment of the disclosure.

FIG. 6 illustrates the method by which the UWB-enabled device controls the UWB-disabled device according to another embodiment of the disclosure.

FIGS. 7A and 7B illustrate a procedure of registering a UWB-disabled device according to an embodiment of the disclosure.

FIGS. 8A and 8B illustrate a procedure of recognizing a UWB-disabled device according to an embodiment of the disclosure.

FIGS. 9A, 9B, and 9C illustrate a first embodiment of the registration procedure of registering a UWB-disabled device according to an embodiment of the disclosure.

FIGS. 10A, 10B, and 10C illustrate a second embodiment of the registration procedure of registering a UWB-disabled device according to an embodiment of the disclosure.

FIG. 11 illustrates a method by which a user device recognizes a target device according to an embodiment of the disclosure.

FIG. 12 is a flowchart illustrating a method of a first UWB device according to an embodiment of the disclosure.

FIG. 13 is a flowchart illustrating a registration operation of the first UWB device according to an embodiment of the disclosure.

FIG. 14 is a flowchart illustrating the registration operation of the first UWB device according to another embodiment of the disclosure.

FIG. 15 illustrates a structure of the electronic device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, according to some embodiments, the “unit” may include one or more processors.

As used herein, the term “terminal” or “device” may be referred to as the term “mobile station (MS)”, “user equipment (UE)”, “user terminal (UT)”, “wireless terminal”, “access terminal (AT)”, “subscriber unit”, “subscriber station (SS)”, “wireless device”, “wireless communication device”, “wireless transmit/receive unit (WTRU)”, “mobile node”, “mobile”, or other terms. Various examples of the terminal may include a cellular phone, a smartphone having a wireless communication function, a personal digital assistant (PDA) having a wireless communication function, a wireless modem, a portable computer having a wireless communication function, an image capture device having a wireless communication function, such as a digital camera, a gaming device having a wireless communication function, a music storage and playback home appliance having a wireless communication function, an Internet home appliance capable of wireless Internet access and browsing, and portable units or terminals having combinations of such functions incorporated therein. Furthermore, the terminal may include, but limited thereto, a machine to machine (M2M) terminal and a machine type communication (MTC) terminal/device. In the specification, the terminal may also be referred to as an electronic device or simply a device.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using a UWB will be described by way of example, but the embodiments of the disclosure may be applied to other communication systems having similar technical backgrounds or channel types. Examples of such communication systems may include a communication system using Bluetooth or Zigbee. Therefore, based on determinations by those skilled in the art, the embodiments of the disclosure may be applied to other communication systems through some modifications without significantly departing from the scope of the disclosure.

In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology is largely divided into a wireless local area network (WLAN) technology and a wireless personal area network (WPAN) technology according to the recognized distance. At this time, the WLAN corresponds to a technology based on IEEE 802.11 capable of accessing a backbone network within a radius of 100 m. Further, the WPAN corresponds to a technology based on IEEE 802.15 and may include Bluetooth, ZigBee, ultra-wideband (UWB), and the like. A wireless network for implementing the wireless network technologies may include a plurality of electronic devices.

The UWB may be a short-distance high-speed wireless communication technology using a wide frequency band higher than or equal to several GHz, a low spectrum density, and a short pulse width (1 to 4 nsec) in a baseband state. The UWB may be a band itself to which UWB communication is applied. The UWB allows secure and accurate ranging between devices. Accordingly, the UWB enables relative location estimation based on the distance between two devices or accurate location estimation of a device based on the distance from fixed devices (of which locations are known).

Specific terms used in the following description are provided to assist understanding of the disclosure, and the use of the specific terms may be modified in different forms without departing from the technical idea of the disclosure.

An “application dedicated file (ADF)” may be a data structure within application data structure capable of hosting, for example, an application or application-specific data.

An “application protocol data unit (APDU)” may be a command and a response used for communication with application data structure within a UWB device.

“Application-specific data” may be, for example, a file structure having a root level and an application level including UWB controlee information and UWB session data required for a UWB session.

A “controller” may be a ranging device for defining and controlling ranging control messages (RCMs) (or control messages).

A “controlee” may be a ranging device using a ranging parameter within an RCM (or a control message) received from a controller.

A “dynamic scrambled timestamp sequence (STS) mode” may be an operation mode in which the STS is not repeated for a ranging session unlike a “static STS mode”. In this mode, the STS may be managed by a ranging device and a ranging session key for generating the STS may be managed by a secure component.

An “applet” may be an applet executed on a secure component including UWB parameters and service data. In the disclosure, the applet may be a FiRa applet defined by the FiRa standard which can be defined by FiRa Consortium.

A “ranging device” may be a device capable of performing UWB ranging. In the disclosure, the ranging device may be an enhanced ranging device (ERDEV) defined in IEEE 802.15.4z or a FiRa device defined by the FiRa standard. The ranging device may be referred to as a UWB device.

A “UWB-enabled application” may be an application for a UWB service. For example, the UWB-enabled application may be an application using a framework API for configuring an OOB connector, a secure service, and/or a UWB service for a UWB session. In the disclosure, the “UWB-enabled application” may be abbreviated as an application or a UWB application. The UWB-enabled application may be a FiRa-enabled application defined by the FiRa standard.

A “framework” may be a component for providing access to a profile, an individual UWB configuration, and/or a notification. The “framework” may be a set (collection) of logical software components including, for example, a profile manager, an OOB connector, a secure service, and/or a UWB service. In the disclosure, the framework may be a FiRa framework defined by the FiRa standard.

An “OOB connector” may be a software component for configuring an out-of-band (OOB) connection (for example, a BLE connection) between ranging devices. In the disclosure, the OOB connector may be a FiRa OOB connector defined by the FiRa standard.

A “profile” may be a predefined set of a UWB and an OOB configuration parameter. In the disclosure, the profile may be a FiRa profile defined by FiRa standard.

A “profile manager” may be a software component for implementing a profile available by a ranging device. In the disclosure, the profile manager may be a FiRa profile manager defined by the FiRa standard.

A “service” may be implementation of a use case for providing a service to an end-user.

A “smart ranging device” may be a ranging device capable of implementing an optional framework API. In the disclosure, the smart ranging device may be a FiRa smart device defined by FiRa standard.

A “global dedicated file (GDF)” may be a root level of application-specific data including data required for configuring a USB session.

A “framework API” may be an API used by a UWB-enabled application for communication with a framework.

An “initiator” may be ranging device initiating a ranging exchange.

An “object identifier (OID)” may be an identifier of an ADF within an application data structure.

An “out-of band (OOB)” may be data communication that does not use a UWB as an underlying wireless technology.

A “ranging data set (RDS)” may be data (for example, a UWB session key, a session ID, or the like) required for configuring a UWB session required to protect confidentiality, authenticity, and integrity.

A “responder” may be a ranging device transmitting a response to an initiator in a ranging exchange.

An “STS” may be a ciphered sequence for increasing integrity and accuracy of ranging measurement timestamps. The STS may be generated from a ranging session key.

A “secure channel” may be a data channel for preventing overhearing and tampering.

A “secure component” may be an entity (for example, an SE or a TEE) having a defined security level which interfaces with a UWBS in order to provide an RDS to the UWBS when, for example, a dynamic STS is used.

A “secure element (SE)” may be a tamper-resistant secure hardware component which can be used as a secure component within a ranging device.

“Secure ranging” may be ranging based on an STS generated through a robust ciphering operation.

A “secure service” may be software component for interfacing with a secure component such as a secure element or a trusted execution environment (TEE).

A “service applet” may be an applet on a secure component handling a service-specific transaction.

“Service data” may be data defined by a service provider, which is required to be transmitted between two ranging devices in order to implement a service.

A “service provider” may be an entity for defining and providing hardware and software required for providing a specific service to an end-user.

A “static STS mode” is an operation mode in which an STS is repeated during a session and does not need to be managed by a secure component.

A “secure UWB service (SUS) applet” may be an applet on an SE communicating with an applet in order to search for data required for enabling a secure UWB session with another ranging device. Further, the SUS applet may transmit corresponding data (information) to a UWBS.

A “UWB service” may be a software component providing access to a UWBS.

A “UWB session” may be a time period from the start of communication between a controller and a controlee through a UWB to the stop of the communication. The UWB session may include ranging, data transmission, or both the ranging and the data transmission.

A “UWB session ID” may be an ID (for example, a 32-bit integer) for identifying a UWB session shared between a controller and a controlee.

A “UWB session key” may be a key used for protecting a UWB session. The UWB session key may be used to generate an STS. In the disclosure, the UWB session key may be a UWB ranging session key (URSK) and may be abbreviated as a session key.

A “UWB subsystem (UWBS)” may be a hardware component implementing UWB PHY and MAC layers (specifications). The UWBS may have an interface for a framework and an interface for a secure component for searching for an RDS. In the disclosure, the UWB PHY and the MAC specifications may be, for example, a FiRa PHY and FiRa MAC specifications defined by FiRa referring to IEEE 802.15.4/4z.

In the description of the disclosure, if it is determined that a detailed description of a relevant known function or configuration makes the subject of the disclosure unclear, the detailed description is omitted.

Various embodiments of the disclosure are described with reference to the accompanying drawings.

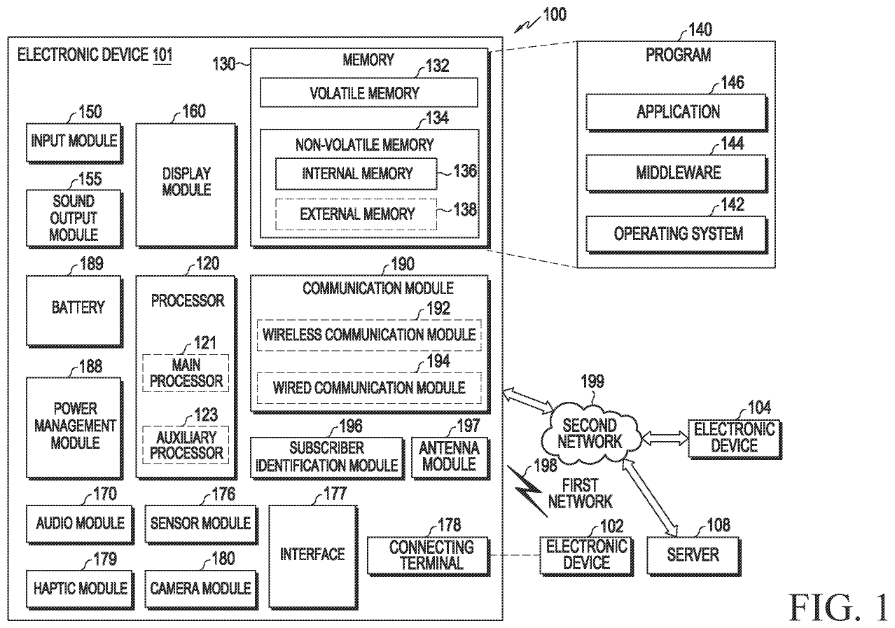

FIG. 1 is a block diagram schematically illustrating an electronic device.

In an embodiment of FIG. 1, the electronic device may be a UWB device or a non-UWB device.

Referring to FIG. 1, in a network environment 100, an electronic device 101 may communicate with an electronic device 102 through a first network 198 (for example, a short-range wireless communication network) or communicate with an electronic device 104 or a server 108 through a second network 199 (for example, a long-range wireless communication network). According to an embodiment, the electronic device 101 may communicate with the electronic device 104 through the server 108. According to an embodiment, the electronic device 101 may include a processor 120, memory 130, an input module 150, a sound output module 155, a display module 160, an audio module 170, a sensor module 176, an interface 177, a connectivity terminal 178, a haptic module 179, a camera module 180, a power management module 188, a battery 189, a communication module 190, a subscriber identification module 196, or an antenna module 197. In some embodiments, at least one (for example, the connectivity terminal 178) of the elements may be omitted in the electronic device 101 or one or more other elements may be added thereto. In some embodiments, some (for example, the sensor module 176, the camera module 180, or the antenna module 197) of the elements may be integrated into one element (for example, the display module 160).

The processor 120 may control at least one other element (for example, hardware or software component) of the electronic device 101 connected to the processor 120 by executing, for example, software (for example, the program 140) and perform various data processing or calculations. According to an embodiment, as at least a part of the data processing or calculations, the processor 120 may store instructions or data received from other elements (for example, the sensor module 176 or the communication module 190) in volatile memory 132, process the instructions or data stored in the volatile memory 132, and store resultant data in non-volatile memory 134. According to an embodiment, the processor 120 may include a main processor 121 (for example, a central processing unit or an application processor) or an auxiliary processor 123 (for example, a graphic processing unit, a neural processing unit (NPU), an image signal processor, a sensor hub processor, or a communication processor) which may operate independently from the main processor or together with the main processor. For example, when the electronic device 101 includes the main processor 121 and the auxiliary processor 123, the auxiliary processor 123 may be configured to use lower power than the main processor 121 or specialized for a predetermined function. The auxiliary processor 123 may be implemented separately from or as a portion of the main processor 121.

For example, the auxiliary processor 123 may control at least some of functions or states related to at least one element (for example, the display module 160, the sensor module 176, or the communication module 190) among the elements of the electronic device 101 on behalf of the main processor 121 while the main processor 121 is in an inactive (for example, sleep) state or while the main processor 121 is in an active (for example, application execution) state. According to an embodiment, the auxiliary processor 123 (for example, an image signal processor or a communication processor) may be implemented as a part of functionally related other elements (for example, the camera module 180 or the communication module 190). According to an embodiment, the auxiliary processor 123 (for example, a neural network processing device) may include a hardware structure specialized for processing an artificial intelligence model. The artificial intelligence model may be generated through machine learning. The learning may be performed by, for example, the electronic device 101 itself performing the artificial intelligence or may be performed through a separate server (for example, the server 108). A learning algorithm may include, for example, supervised learning, unsupervised learning, semi-supervised learning, or reinforcement learning, but is not limited thereto. The artificial intelligence model may include a plurality of artificial neural network layers. The artificial neural network may be one of a deep neural network (DNN), a convolutional neural network (CNN), a recurrent neural network (RNN), a restricted Boltzmann machine (BBM), a deep belief network (DBN), a bidirectional recurrent deep neural network (BRDNN), deep Q-networks, or a combination of two or more thereof, but is not limited thereto. The artificial intelligence model may additionally or alternatively include a software structure as well as the hardware structure.

The memory 130 may store various pieces of data used by at least one element (for example, the processor 120 or the sensor module 176) of the electronic device 101. Data may include, for example, software (for example, the program 140) and input data or output data for a command related thereto. The memory 130 may include the volatile memory 132 or the non-volatile memory 134.

The program 140 may be stored in the memory 130 as software and may include, for example, an operating system 142, middleware 144, or an application 146.

The input module 150 may receive instructions or data to be used by the element (For example, the processor 120) of the electronic device 101 from the outside (for example, a user) of the electronic device 101. The input module 150 may include, for example, a microphone, a mouse, a keyboard, a key (for example, a button), or a digital pen (for example, a stylus pen).

The sound output module 155 may output a sound signal to the outside of the electronic device 101. The sound output module 155 may include, for example, a speaker or a receiver. The speaker may be used for the general use such as multimedia reproduction or recording reproduction. The receiver may be used to receive an incoming call. According to an embodiment, the receiver may be implemented separately from the speaker or as a portion of the speaker.

The display module 160 may visually provide information to the outside (for example, the user) of the electronic device 101. The display module 160 may include, for example, a display, a hologram device, or a projector, and a control circuit for controlling the corresponding device. According to an embodiment, the display module 160 may include a touch sensor configured to detect a touch or a pressure sensor configured to measure an intensity of force generated by the touch.

The audio module 170 may convert a sound into an electric signal or, conversely, convert an electric signal into a sound. According to an embodiment, the audio module 170 may acquire a sound through the input module 150 or output a sound through the sound output module 155 or an external electronic device (for example, the electronic device 102) (for example, a speaker or headphones) directly or wirelessly connected to the electronic device 101.

The sensor module 176 may detect an operation state (for example, power or temperature) of the electronic device 101 or an external environment state (for example, a user state) and generate an electric signal or a data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an Infrared (IR) sensor, a biometric sensor, a temperature sensor, a humidity sensor, or an illumination sensor.

The interface 177 may support one or more predetermined protocols which can be used for a direct or wireless connection of the electronic device 101 with an external electronic device (for example, the electronic device 102). According to an embodiment, the interface 177 may include, for example, a high-definition multimedia interface (HDMI), a universal serial bus (USB) interface, an SD card interface, or an audio interface.

The connectivity terminal 178 may include a connector through which the electronic device 101 can be physically connected to the external electronic device (for example, the electronic device 102). According to an embodiment, the connectivity terminal 178 may include, for example, an HDMI connector, a USB connector, an SD card connector, or an audio connector (for example, a headphone connector).

The haptic module 179 may convert an electric signal into mechanical stimulation (for example, vibration or motion) or electrical stimulation that the user can recognize through the sense of touch or the sense of movement. According to an embodiment, the haptic module 179 may include, for example, a motor, a piezoelectric element, or an electrical stimulation device.

The camera module 180 may capture a still image and a moving image. According to an embodiment, the camera module 180 may include one or more lenses, image sensors, image signal processors, or flashes.

The power management module 188 may mange the power supplied to the electronic device 101. According to an embodiment, the power management module 188 may be implemented at least in part by, for example, a Power Management Integrated Circuit (PMIC).

The battery 189 may supply power to at least one element of the electronic device 101. According to an embodiment, the battery 189 may include, for example, a non-rechargeable primary cell, a rechargeable secondary cell, or a fuel cell.

The communication module 190 may support establishment of a direct (for example, wired) communication channel or a wireless communication channel between the electronic device 101 and an external electronic device (for example, the electronic device 102, the electronic device 104, or the server 108) and performance of communication through the established communication channel. The communication module 190 may include one or more communication processors which operate independently from the processor 120 (for example, application processor) and support direct (for example, wired) communication or wireless communication. According to an embodiment, the communication module 190 may include a wireless communication module 192 (for example, a cellular communication module, a short-range wireless communication module, or a global navigation satellite system (GNSS) communication module) or a wired communication module 194 (for example, a local area network (LAN) communication module or a power line communication module). Among the communication modules, the corresponding communication module may communicate with the eternal electronic device 104 through the first network 198 (for example, a short-range communication network such as Bluetooth, Wi-Fi (wireless fidelity) direct, or infrared data association (IrDA)) or the second network 199 (for example, a long-range communication network such as a legacy cellular network, a 5G network, a next-generation communication network, the Internet, or a computer network (for example, LAN or WAN)). Such various types of communication modules may be integrated into a single component (for example, a single chip) or may be implemented by a plurality of components (for example, a plurality of chips) separated from each other. The wireless communication module 192 may identify or authenticate the electronic device 101 within the communication network such as the first network 198 or the second network 199 using subscriber information (for example, an international mobile subscriber identity (IMSI)) stored in the subscriber identification module 196.

The wireless communication module 192 may support a 5G network and next-generation communication technology after the 4G network, for example, a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (for example, an mmWave band) in order to achieve, for example, a high data transmission rate. The wireless communication module 192 may support various technologies, for example, beamforming, massive multiple-input and multiple-output (MIMO), full dimensional (FD)-MIMO, array antenna, analog beamforming, or large scale antenna for guaranteeing the performance in the high-frequency band. The wireless communication module 192 may support various requirements defined by the electronic device 101, the external electronic device (for example, the electronic device 104), or the network system (for example, the second network 199). According to an embodiment, the wireless communication module 192 may support a peak data rate (for example, 20 Gbps or higher) for realizing eMBB, loss coverage (for example, 164 dB or lower) for realizing mMTC, or U-plane latency (for example, 0.5 ms or lower in each of downlink (DL) and uplink (UL) or 1 ms of roundtrip or lower) for realizing URLCC.

The antenna module 197 may transmit a signal or power to the outside (for example, an external electronic device) or receive the same from the outside. According to an embodiment, the antenna module 197 may include an antenna including a conductor formed on a substrate (for example, a PCB) or a radiator configured in a conductive pattern. According to an embodiment, the antenna module 197 may include a plurality of antennas (for example, array antennas). In this case, at least one antenna suitable for a communication scheme used for a communication network, such as the first network 198 or the second network 199, may be selected from among the plurality of antennas by, for example, the communication module 190. The signal or power may be transmitted or received between the communication module 190 and the external electronic device through at least one selected antenna. According to some embodiments, another component (for example, RFIC) as well as the radiator may be additionally configured as a portion of the antenna module 197.

According to various embodiments, the antenna module 197 may configure an mmWave antenna module. According to an embodiment, the mmWave antenna module may include an RFIC which is disposed on printed circuit board, on a first surface (for example, a lower side) of the printed circuit board, or adjacent thereto and may support a predetermined high-frequency band (for example, mmWave band) and a plurality of antennas (for example, array antennas) which is disposed on a second surface (for example, an upper side or a lateral side) of the printed circuit board or adjacent thereto and may transmit or receive a signal in the predetermined high-frequency band.

At least some of the elements may be connected to each other through a communication scheme between peripheral devices (for example, a bus, general purpose input/output (GPIO), a serial peripheral interface (SPI), or a mobile industry processor interface (MIPI)) and exchange signals (for example, instructions or data) therebetween. According to an embodiment, instructions or data may be transmitted or received between the electronic device 101 and the external electronic device 104 through the server 108 connected to a second network 199. The external electronic device 102 or 104 may a device which is the same type as or different type from the electronic device 101. According to an embodiment, all or some of the operations performed by the electronic device 101 may be performed by one or more external electronic devices among the external electronic devices 102, 104, and the server 108. For example, when the electronic device 101 should perform a function or a service automatically or in response to a request from a user or another device, the electronic device 101 may alternatively or additionally make a request for performing at least a portion of the function or the service to one or more external electronic devices instead of performing the function or the service by itself. The one or more external electronic devices receiving the request may perform at least a portion of the requested function or service or an additional function or service related to the request and transfer the result of execution to the electronic device 101. The electronic device 101 may provide the result or additionally process the result and provide the processed result as at least a portion of a response to the request. To this end, for example, cloud-computing, distributed-computing, mobile edge computing (MEC), or client-server-computing technology may be used. The electronic device 101 may provide ultra-low latency service by using, for example, distributed computing or mobile edge computing. In another embodiment, the external electronic device 104 may include an Internet of things (IoT) device. The server 108 may be an intelligent server using machine learning and/or a neural network. According to an embodiment, the external electronic device 104 or the server 108 may be included in the second network 199. The electronic device 101 may be applied to intelligent services (for example, smart phone, smart city, smart car, or health care), based on the 5G communication technology and the IoT-related technology.

The electronic device according to various embodiments of the disclosure may be a device in various types. The electronic device may include, for example, a portable communication device (for example, a smartphone), a computer device, a portable multimedia device, a portable medical device, a camera, a wearable device, or a home appliance. The electronic device according to an embodiment of the disclosure is not limited the above-described devices.

The various embodiments of the disclosure and the terms used herein are not intended to limit the technical features disclosed herein to specific implementation forms, and should be understood to include various modifications, equivalents, and/or alternatives to the corresponding embodiments. In connection with the description of drawings, similar reference numerals may be used for similar or related elements. A singular form of the noun corresponding to an item may include one or a plurality of items unless clearly specially indicated in context. In the disclosure, each of the phrases “A or B”, “at least one of A and B”, at least one of A or B”, “A, B, or C”, “at least one of A, B, and C”, and “at least one of A, B, or C” may include one of the listed items in the corresponding phrase among the phrases or all available combinations thereof. The terms “first” or “second” may be used to simply distinguish a corresponding element from another corresponding element, and do not limit corresponding elements in another aspect (for example, importance or order). When any (for example, first) element is “coupled with” or “connected with” another (for example, second) element “functionally” or “in communication” or without “functionally” or “in communication”, it means that the element may be connected to the other element directly (for example, wiredly), wirelessly, or through a third element.

The term “module” used in various embodiments of the disclosure may include a unit implemented in hardware, software, or firmware, and interchangeably used with the term, for example, logic, a logical block, a component, or a circuit. The module may be an integrated component or a minimum unit of the component or a part thereof performing one or more functions. For example, according to an embodiment, the module may be implemented in the form of an application-specific integrated circuit (ASIC).

Various embodiments of this document may be implemented as software (for example, the program 140) including one or more instructions stored in a machine (for example, the electronic device 101)-readable storage medium (for example, the internal memory 136 or the external memory 138). For example, a processor (for example, the processor 120) of a device (for example, the electronic device 101) may call at least one instruction among one or more instructions stored in the storage medium and execute the instruction. This allows the device to perform at least one function according to at least one loaded instruction. The one or more instructions may include code generated by a compiler or code which can be executed by an interpreter. The machine-readable storage medium may be provided in the form of a non-transitory storage medium. The term “non-transitory” means that the storage medium is a tangible device and does not include a signal (for example, an electromagnetic wave) and does not distinguish the case in which data is stored in the storage medium semi-permanently and the case in which data is stored in the storage medium temporarily.

According to an embodiment, a method according to various embodiments of this document may be included and provided in a computer program product. The computer program product may be traded as a product between a seller and a buyer. The computer program product may be distributed in the form of a machine-readable storage medium (for example, compact disc read-only memory (CD-ROM)) or distributed online (for example, downloaded or uploaded) through an application store (for example, Play Store™) or directly between two user devices (for example, smart phones). If distributed online, at least a portion of the computer program products may be at least temporarily stored in or temporarily generated by the machine-readable storage medium, such as memory of the manufacturer's server, a server of the application store, or a relay server.

According to various embodiments, each element (for example, the module or the program) of the above-described elements may include a single entity or a plurality of entities, and some of the plurality of entities may be disposed separately from other elements. According to various embodiments, one or more elements of the corresponding elements or operations may be omitted, or one or more other elements or operations may be added. Alternatively or additionally, the plurality of elements (for example, the module or the program) may be integrated into one element. In this case, the integrated element may perform one or more functions of each of the plurality of elements in the same way or similarly to being performed by the corresponding element among the plurality of elements before the integration. According to various embodiments, operations performed by the module, the program, or another element may be performed sequentially, in parallel, repeatedly, or heuristically, one or more of the operations may be performed in another order, or omitted, or one or more other operations may be added.

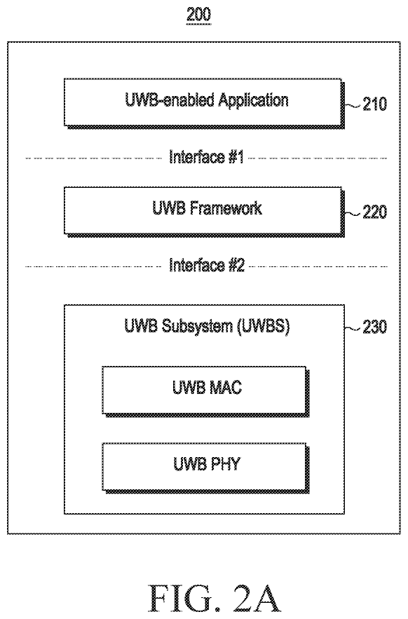

FIG. 2A illustrates an example of architecture of a UWB device.

In the disclosure, a UWB device 200 is an example of the electronic device of FIG. 1 and may be an electronic device supporting UWB communication. The UWB device 200 may be, for example, a ranging device (RDEV) supporting UWB ranging. In an embodiment, the ranging device may be an enhanced ranging device (ERDEV) defined in IEEE 802.15.4z or a FiRa device defined by the FiRa standard.

In an embodiment of FIG. 2A, the UWB device 200 may interact with another UWB device through a UWB session.

Further, the UWB device 200 may implement a first interface (interface #1) which is an interface between a UWB-enabled application 210 and a UWB framework 220, and the first interface may allow the UWB-enabled application 210 in the UWB device 200 to use UWB capabilities of the UWB device 200 in a predetermined scheme. In an embodiment, the first interface may be a framework API or a proprietary interface, but is not limited thereto.

Further, the UWB device 200 may implement a second interface (interface #2) which is an interface between the UWB framework 210 and a UWB subsystem (UWBS) 230. In an embodiment, the second interface may be a UWB command interface (UCI) or a proprietary interface, but is not limited thereto.

Referring to FIG. 2A, the UWB device 200 may include the UWB-enabled application 210, a framework (UWB framework) 220, and/or a UWBS 230 including a UWB MAC layer and a UWB physical layer. According to an embodiment, some entities may not be included in the UWB device or an additional entity (for example, security layer) may be further included.

The UWB-enabled application 210 may trigger a configuration of a UWB session by the UWBS 230 through the first interface. Further, the UWB-enabled application 210 may use one of the predefined profiles. For example, the UWB-enabled application 210 may use one of the profiles defined in the FiRa standard or a custom profile. The UWB-enabled application 210 may handle relevant events such as service discovery, ranging notifications, and/or error conditions through the first interface.

The framework 220 may provide access to a profile, an individual UWB configuration, and/or a notification. Further, the framework 220 may support at least one of a function for performing UWB ranging and transaction, a function for providing an interface for an application and the UWBS 230, or a function for estimating a location of the UWB device 200. The framework 220 may be a set of software components. As described above, the UWB-enabled application 210 may interface with the framework 220 through the first interface, and the framework 220 may interface with the UWBS 230 through the second interface.

Meanwhile, in the disclosure, the UWB-enabled application 210 and/or the framework 220 may be implemented by an application processor (AP) (or processor). Accordingly, in the disclosure, it may be understood that the operation of the UWB-enabled application 210 and/or the framework 220 may be performed by the AP (or processor). In the disclosure, the framework may be referred to as an AP or a processor.

The UWBS 230 may be a hardware component including a UWB MAC layer and a UWB physical layer. The UWBS 230 may manage a UWB session and communicate with a UWBS of another UWB device. The UWBS 230 may interface with the framework 220 through the second interface and acquire security data from the secure component. In an embodiment, the framework (or application processor) 220 may transmit a command to the UWBS 230 through UCI, and the UWBS 230 may transfer a response to the instruction to the framework 220. The UWBS 230 may transfer a notification to the framework 220 through UCI.

FIG. 2B illustrates an example of a configuration of the framework of the UWB device.

The framework of the UWB device in FIG. 2B may be an example of the framework of the UWB device in FIG. 2A.

Referring to FIG. 2B, the framework 220 may include software components, for example, a profile manager 221, an OOB connector(S) 222, a secure service 223, and/or a UWB service 224.

The profile manager 221 may serve to manage profiles which can be used by the UWB device. The profile may be a set of parameter required for establishing communication between UWB devices. For example, the profile may include a parameter indicating whether OOB secure channel is used, a UWB/OOB configuration parameters, a parameter indicating whether the use of a specific secure component is mandatory, and/or a parameter related to a file format of an ADF. A UWB-enabled application 210 may communicate with the profile manager 221 through a first interface (for example, a framework API).

The OOB connector 222 may serve to make an OOB connection with another device. The OOB connector 222 may handle an OOB step including a discovery step and a connection step. The OOB component (for example, a BLE component) 250 may be connected to the OOB connector 222.

The secure service 223 may serve to interface with the secure component 240 such as an SE or a TEE.

The UWB service 224 may serve to manage the UWBS 230. The UWB service 224 may provide access to the UWBS 230 from the profile manager 221 by implementing a second interface.

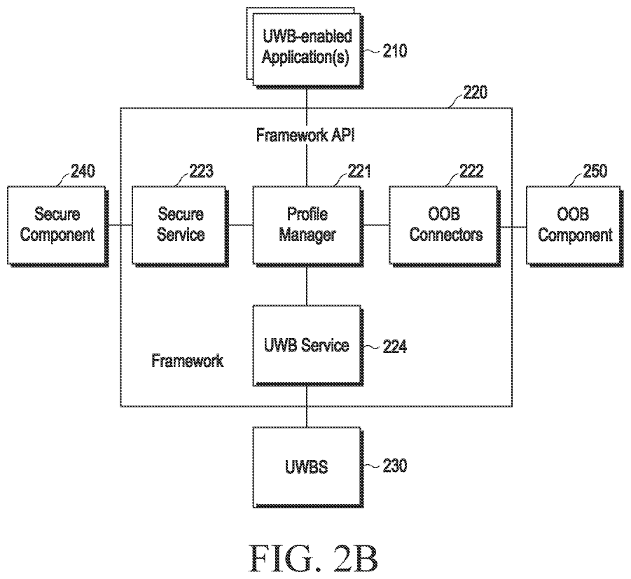

FIG. 3 illustrates an example of a configuration of a communication system including a UWB device.

Referring to FIG. 3, a communication system 300 includes a first UWB device 310 and a second UWB device 320. In an embodiment, the first UWB device 310 and the second UWB device 320 may be, for example, the UWB device of FIG. 2 or electronic devices including the UWB device of FIG. 2.

The first UWB device 310 may host, for example, one or more UWB-enabled applications which 311 can be installed by a user (for example, a mobile phone). This may be based on, for example, a framework API. The second UWB device 320 may use a proprietary interface to implement, for example, a specific UWB-enabled application without providing the framework API. Meanwhile, unlike what is illustrated, both the first UWB device 310 and the second UWB device 320 may be ranging devices using the framework API or both the first UWB device 310 and the second UWB device 320 may be ranging devices using the proprietary interface according to an embodiment.

The first UWB device 310 and the second UWB device 320 may include UWB-enabled application layers 311 and 321, frameworks 312 and 322, OOB connectors 313 and 323, secure components 314 and 324, and/or UWBSs 315 and 325. Meanwhile, in the disclosure, the OOB components 313 and 323 and/or the secure components 314 and 324 are optional components and may not be included in the UWB devices according to an embodiment.

The frameworks 312 and 322 may serve to provide access to a profile, an individual UWB configuration, and/or a notification. The frameworks 312 and 322 are sets of software components and may include, for example, a profile manager, an OOB connector, a secure service, and/or a UWB service. The above description is referred to for each component.

The OOB connectors 313 and 323 may be hardware components including a MAC layer and/or a physical layer for OOB communication (for example, BLE communication). The OOB connectors 313 and 323 may communicate with an OOB component of another device. In an embodiment, the first UWB device 310 and the second UWB device 320 may generate an OOB connection (channel) through the OOB connectors 313 and 323 and exchange parameters for configuring a UWB session through the OOB channel. In the disclosure, the OOB connectors 313 and 323 may be referred to as OOB subsystems.

The secure components 314 and 324 may be hardware components interfacing with the framework and/or the UWBS to provide the RDS.

The UWBSs 315 and 325 may be hardware components including a UWB MAC layer and a UWB physical layer. The UWBS may manage a session and communication with a UWBS of another UWB device. In an embodiment, the first UWB device 310 and the second UWB device 320 may perform UWB ranging and service data transaction through a UWB session configured through the UWBS by using the exchanged parameters.

As described above, in the disclosure, the UWB-enabled application layers 311 and 321 and/or the frameworks 312 and 322 may be implemented by an application processor (AP) (or processor). Accordingly, in the disclosure, it may be understood that the operation of the UWB-enabled application layers 311 and 321 and/or the frameworks 312 and 322 may be performed by the AP (or processor).

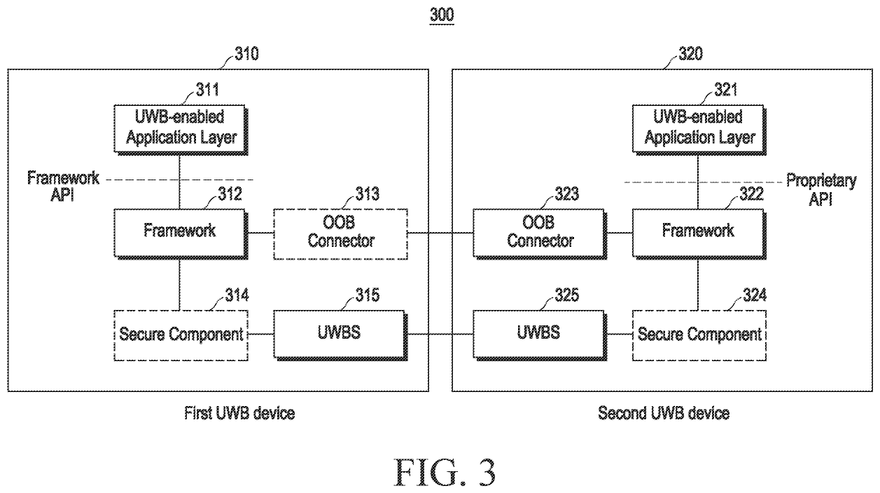

FIG. 4 illustrates a UWB ranging operation between UWB devices.

UWB devices 41 and 42 of FIG. 4 may be the UWB devices illustrated in FIGS. 1 to 3 but are not limited thereto, and may be electronic devices in various types supporting UWB ranging.

In an embodiment of FIG. 4, the first UWB device 41 may be a ranging device which initiates ranging exchange by transmitting a first ranging frame (ranging initiation message). In the disclosure, the first UWB device 41 may be referred to as an initiator.

The second UWB device 42 may be a ranging device which responds to the ranging initiation message received from the initiator. In the disclosure, the second UWB device 42 may be referred to as a responder. In an embodiment, the responder may transmit a ranging response message.

In an embodiment, the first UWB device 41 may be a controller, and the second UWB device 42 may be a controlee. The opposite case is also possible. The controller may be a ranging device which defines and controls a ranging characteristic by transmitting a control message. The controlee may be a ranging device which uses the ranging characteristic configured through the control message from the controller.

In an embodiment, the first UWB device 41 and the second UWB device 42 may perform a ranging operation through a preset ranging method. In an embodiment, the ranging method may include a two-way ranging (TWR) method and/or a one-way ranging (OWR) method. In an embodiment, the TWR method may include single-sided two-way ranging (SS-TWR) and/or double-sided two-way ranging (DS-TWR). For such ranging methods, refer to the IEEE 802.15.4/4z standard and the FiRa standard that references the same.

Referring to FIG. 4, for the TWR, the first UWB device 41 may transmit a ranging initiation message to the second UWB device 42 in operation 410.

The second UWB device 42 may transmit a ranging response message to the first UWB device 41 in operation 420. As an embodiment, the ranging response message may be generated based on the ranging initiation message. Through an operation of exchanging the UWB ranging message, the first UWB device 41 and/or the second UWB device 42 may acquire distance information and/or direction information and identify relative locations and/or directions of the UWB devices, based thereon. For the above, refer to the description of the IEEE 802.15.4/4z standard and the FiRa standard that references the same. In the case of the DS-TWR method, the first UWB device 41 may further transmit a ranging final message to the second UWB device 42.

In an embodiment, the distance information may include time of fight (ToF) information (ToF measurement information). ToF may correspond to UWB propagation time between a transmitter and a receiver. ToF may provide accurate estimation of relative locations of two devices through message timestamping. The ToF information may be measured by one ranging device or both the two ranging devices and exchanged between the initiator and the responder through a predefined signaling method (for example, a control message including a UWB ranging result).

In an embodiment, the direction information may include angle of arrival (AoA) information (AoA measurement information). The AoA may be acquired through measurement of phase difference of signals arriving at antennas or difference of arrival time. The AoA information may include AoA azimuth (horizontal angle) and AoA elevation (vertical angle). The AoA information may be used to determine relative locations of UWB devices along with the ToF information. The AoA information may be measured by one ranging device or both the two ranging devices and exchanged between the initiator and the responder through a predefined signaling method (for example, a control message including a UWB ranging result).

In an embodiment, a PHY packet including a ranging frame (for example, the UWB initiation message/response message) may include an STS. Whether the PHY packet includes the STS, a location including the STS, and a format of the packet may vary depending on an STS packet configuration. The STS corresponds to an encrypted sequence used to increase integrity and accuracy of the ranging measurement timestamp. When the STS is used, the initiator and the responder should share an STS seed (for example, a ranging session key) used to generate and restore the STS in advance. Sharing of the ranging session key may be performed through a secure channel configured through, for example, BLE.

Hereinafter, various embodiments of a method of registering and recognizing UWB-disabled device through UWB ranging between UWB-enabled devices (apparatuses) are described with reference to respective drawings.

In the disclosure, it is assumed that one of the UWB-enabled devices is a reference device (for example, TV) supporting UWB ranging and the other one is a user device (for example, a smartphone of the user) supporting UWB ranging, and various embodiments of the disclosure are described. However, it is not limited thereto, and the UWB-enabled device may be various electronic devices supporting UWB ranging. In an embodiment, the reference device and the user device may be the UWB devices illustrated in FIGS. 1 to 4. For example, the reference device and the user device may correspond to RDEVs or ERDEVs, or may be electronic devices including the same.

In the disclosure, the user device supporting UWB ranging may be referred to as a UWB user device, a user device, a first UWB-enabled device, a first UWB device, or a first UWB apparatus. Further, the reference device supporting UWB ranging may be referred to as a UWB reference device, a reference device, a second UWB-enabled device, a second UWB device, or a second UWB apparatus.

In the disclosure, the UWB-disabled device is a device to be controlled by a UWB-enabled device (for example, the user device) and may be referred to as a target device, a non-UWB device, or a non-UWB apparatus.

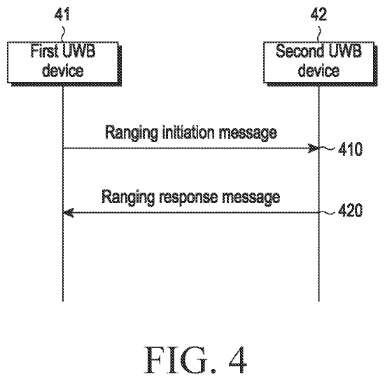

FIG. 5 illustrates a method by which a UWB-enabled device controls a UWB-disabled device according to an embodiment of the disclosure.

In an embodiment of FIG. 5, a UWB user device 510 (for example, a smartphone of the user) initiates a first method of pointing and controlling a target device 530 (for example, an air conditioner) corresponding to a UWB-disabled device by using a UWB ranging result with a UWB reference device 520 (for example, TV).

As an embodiment, a UWB ranging operation between the user device 510 and the reference device 520 may follow the UWB ranging operation of FIG. 4. For example, the UWB ranging operation of the TWR methods of FIG. 4 may be performed. In this case, the user device 510 may serve as an initiator, and the reference device 520 may serve as a responder. The opposite case is also possible.

In an embodiment of FIG. 5, the user device 510 may point one point of the target device 530, identify a location of the target device 530, and point and control the target device 530, based thereon. Accordingly, in the case of the embodiment of FIG. 5, the user device 510 may need to directly measure a distance between the user device 510 and the target device 530 in order to point and control the target device 530. As an embodiment, the user device 510 may measure the distance to the target device 530 by using a function, for example, ToF/Radar.

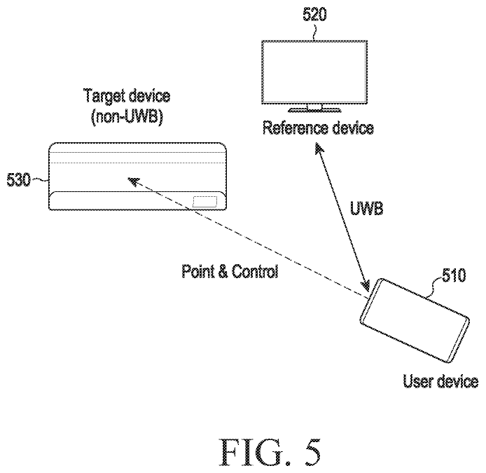

FIG. 6 illustrates the method by which the UWB-enabled device controls the UWB-disabled device according to another embodiment of the disclosure.

In an embodiment of FIG. 6, a UWB user device 610 (for example, a smartphone of the user) initiates a second method of pointing and controlling a target device 630 (for example, an air conditioner) corresponding to a UWB-disabled device by using a UWB ranging result with a UWB reference device 620 (for example, TV).

As an embodiment, a UWB ranging operation between the user device 610 and the reference device 620 may follow the UWB ranging operation of FIG. 4. For example, the UWB ranging operation of the TWR methods of FIG. 4 may be performed. In this case, the user device 610 may serve as an initiator, and the reference device 620 may serve as a responder. The opposite case is also possible.

In an embodiment of FIG. 6, the user device 610 may point a plurality of points of the target device 630 (for example, a plurality of corners of the target device 630), identify a location/area of the target device 630, and point and control the target device 630, based thereon. Accordingly, unlike the embodiment of FIG. 5, the user device 610 may need to directly measure the distance between the user device 610 and the target device 630 to point and control the target device 630 in the embodiment of FIG. 6. In other words, the user device 610 may point and control the target device 630 corresponding to the UWB-disabled device even though the distance between the user device 610 and the target device 630 is not directly measured/calculated using the function, for example, UWB/ToF/Radar.

Hereinafter, various embodiments of a procedure of registering and recognizing a target device to point/control the target device are descried with reference to respective drawings.

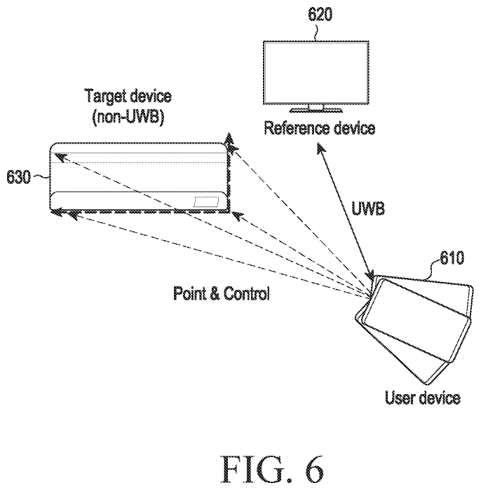

FIG. 7 illustrates a procedure of registering a UWB-disabled device according to an embodiment of the disclosure.

In an embodiment of FIG. 7, the registration procedure (operation) may include a procedure (operation) for identifying (or determining) a location and/or size (area) of a target device 730 which is a UWB-disabled device. In the registration procedure, a UWB ranging result between a user device 710 and a reference device 720 which are UWB-enabled devices may be used to identify the location and/or size of the target device 730.

In an embodiment, the registration procedure may be performed by the user device 710. However, it is not limited thereto, and the registration procedure may be performed by the reference device 720 according to an embodiment.

FIG. 7A illustrates a first option of the registration procedure. The first option corresponds to a method by which the user device 710 located at a predetermined distance (d) from the target device 730 identifies the location and/or the size of the target device 730 by providing a guide (user guide) to point to at least two points of the target device 730. For example, as illustrated in FIG. 7A, the user device 710 is located at the distance “d” from the target device 730 and point to two corners (for example, a lower left corner and a lower right corner) of the target device 730, so as to identify the location and/or the size of the target device 730.

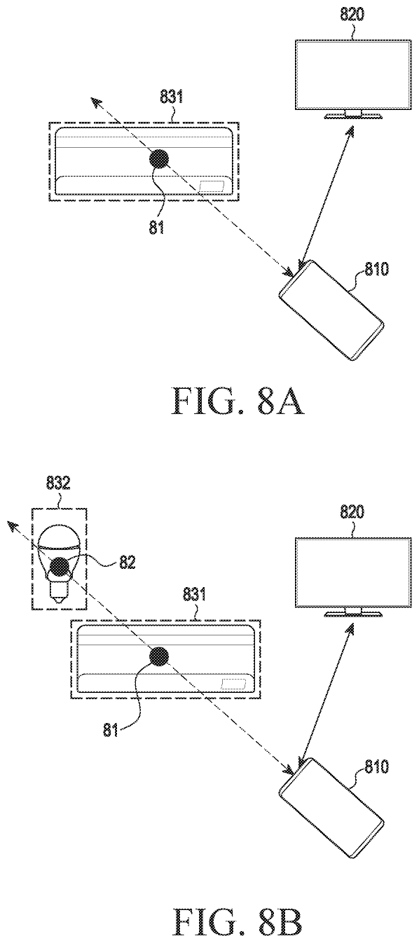

As an embodiment, the number of points on the target device 730 to which the user device 710 points may vary depending on settings. As the number of pointed points on the target device 730 increases, the accuracy of identification of the location and/or the size of the target device 730 increases but the time spent for the registration procedure becomes longer. Accordingly, it may be required to configure the appropriate number. As an embodiment, it is required to configure the appropriate number, based on a characteristic (for example, form/shape) of the target device 730. For example, when the target device 730 has a rectangular shape, the number of pointed points on the target device 730 may be configured as 3. An example of a method of the first option is described hereinafter with reference to FIG. 9.

FIG. 7B illustrates a second option of the registration procedure. The second option corresponds to a method by which the user device 710 identifies the location and/or the size of the target device 730 by providing a guide to point to at least two points of the target device 730 at different locations. In an embodiment of FIG. 7B, the user device 710 should point to the target device 730 at at least two locations (points). For example, as illustrated in FIG. 7B, the user device 710 may identify the location and/or the size of the target device 730 by pointing to two points (for example, a lower left corner 72 and a lower right corner 71) of the target device 730 at a first location (Loc. 1) and pointing to the two points (for example, the lower left corner 72 and the lower right corner 71) of the target device 730 at a second location (Loc. 2).

As an embodiment, the number of points on the target device 730 to which the user device 710 points may vary depending on settings. As the number of pointed points on the target device 730 increases, the accuracy of the identified location and/or size of the target device 730 increases but the time spent for the registration procedure becomes longer. Accordingly, it may be required to configure the appropriate number. As an embodiment, the appropriate number may be configured based on a characteristic (for example, form/shape) of the target device 730. For example, when the target device 730 has a rectangular shape, the number of pointed points on the target device 730 may be configured as 3.

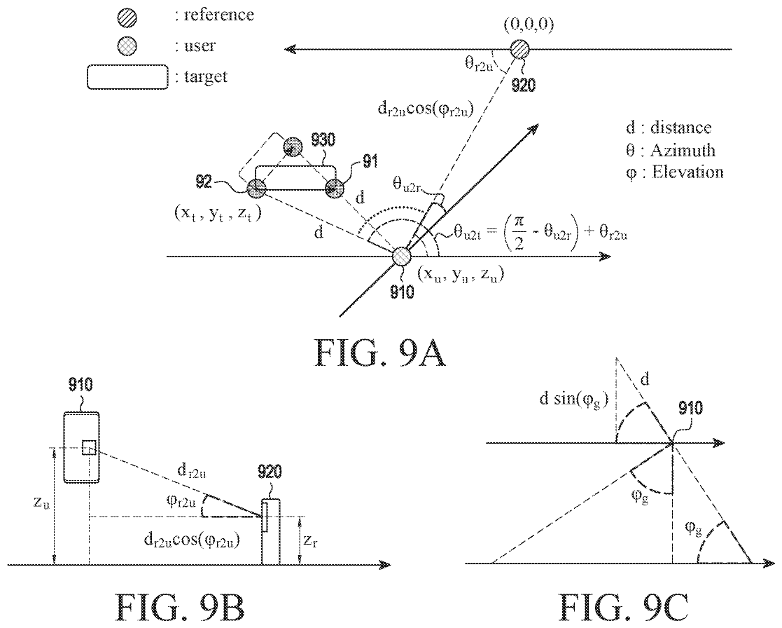

Further, the number of locations at which the user device 710 points to the target device 730 may vary depending on settings. As the number of locations at which the user device 710 points to increases, the accuracy of the identified location and/or size of the target device 730 increases but the time spent for the registration procedure becomes longer. Accordingly, it may be required to configure the appropriate number. As an embodiment, the appropriate number may be configured according to priorities of the quick registration and/or the accuracy of identification of the location/size. For example, when the quick registration has a higher priority than the identification accuracy, the number of locations at which the user device 710 points to may be configured as a minimum value (for example, 2). Alternatively, when the identification accuracy has a higher priority than the quick registration, the number of locations at which the user device 710 points to may be configured as a value larger than 2. For example, an example of the method of the second option is described hereinafter with reference to FIG. 10.

Meanwhile, the case in which the number of user devices for the registration procedure is 1 is described as an example in the embodiment of FIG. 7, but the embodiments is not limited thereto. For example, even when the number of user devices is 2 or more, the above-described options of the registration operations may be applied.

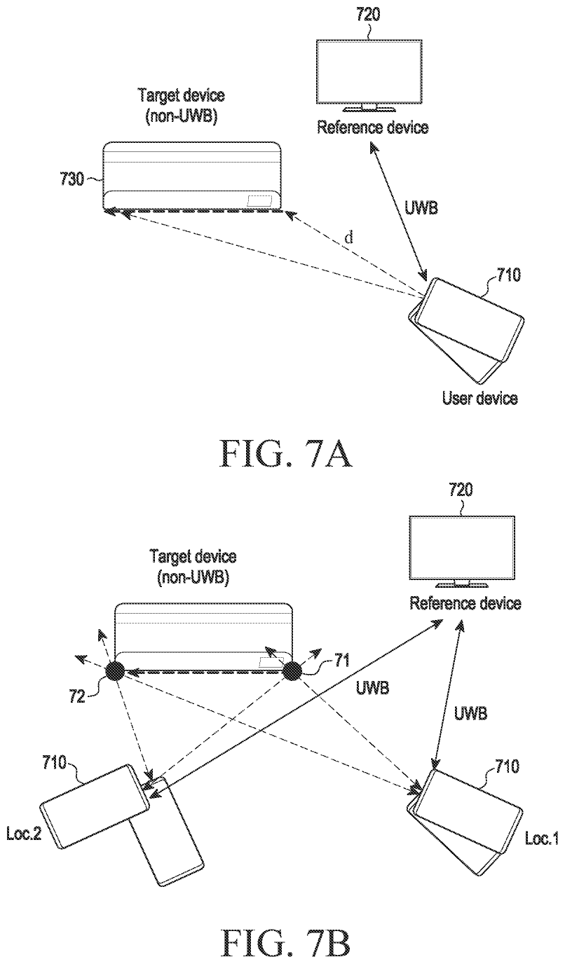

FIG. 8 illustrates a procedure of recognizing a UWB-disabled device according to an embodiment of the disclosure.

In an embodiment of FIG. 8, the recognition procedure (operation) may include a procedure (operation) for identifying (or determining) whether a user device 810 performs pointing in order to control the registered UWB-disabled devices (for example, registered target devices 831 and 832 according to one of the methods (options) of FIG. 7A/B). That is, the recognition procedure may include a procedure of recognizing the target devices 831 and 832 which are to be controlled through pointing. In the recognition procedure, a UWB ranging result between the user device 810 and a reference device 820 which are UWB-enabled devices may be used to identify the current location of the user device 810.

In an embodiment, the recognition procedure may be performed by the user device 810. However, it is not limited thereto, and the recognition procedure may be performed by the reference device 820 according to an embodiment.

As an embodiment, the recognition procedure may include two operations, for example, a first operation illustrated in FIG. 8A and a second operation illustrated in FIG. 8B.

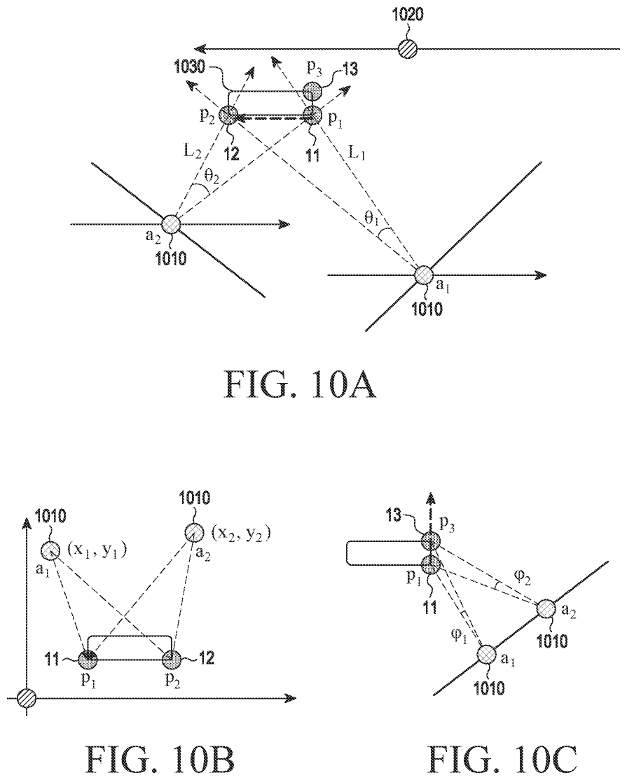

Referring to FIG. 8A, the first operation may be an operation of identifying (or calculating) an intersection point 81 between a linear component of a direction to which the user device 810 points and a three-dimensional plane corresponding to the registered target device 831. An example of a method of calculating the intersection point is described hereinafter with reference to FIG. 11.

As an embodiment, the three-dimensional plane corresponding to the target device 831 may be a three-dimensional plane corresponding to the size of the target device 830 identified through the registration procedure. For example, as illustrated in FIG. 8A, it may be a three-dimensional plane corresponding to a figure (for example, a rectangle) configured by connecting respective corners of the target device 831 identified through the registration procedure.

Referring to FIG. 8B, the second operation may be an operation of selecting (or determining) a target device which the user device 810 (or the user of the user device 810) desires to actually control when the number of intersection points identified in the first operation is plural. For example, as illustrated in FIG. 8B, when the intersection point 81 with the three-dimensional plane corresponding to the first target device 831 and the intersection point 82 with the three-dimensional plane corresponding to the second target device 832 are identified through the first operation, the user device 810 may select one target device to be controlled through the second operation.

In an embodiment, the second operation may include an operation of providing user experience/user interface (UX/UI) information for selecting one target device from among the plurality of target devices 831 and 832 through the user device 810. In this case, the user may select one target device to be controlled, based on the provided UX/UI information.

FIG. 9 illustrates a first embodiment of the registration procedure of registering a UWB-disabled device according to an embodiment of the disclosure.

An embodiment of FIG. 9 may be an embodiment of the registration procedure following the first option of the registration procedure illustrated in FIG. 7A.

In the embodiment of FIG. 9, it is assumed that a user device 910 is located at a distance “d” from a target device 930 and provides a guide (user guide) to point to at least two points (locations) of the target device 930 to the user.

The registration procedure of FIG. 9 may include an operation (first operation) of identifying the location of the user device 910, based on the location of the reference device 920 and/or an operation (second operation) of identifying the location and/or the size of the target device 930, based on the location of the reference device 920.

Through the registration procedure, the location and/or the size of the target device 930 relative to the location (reference location) of the reference device 920 may be identified. The identified location and/or size of the target device 930 may be stored and used for the recognition procedure performed thereafter.

In the embodiment of FIG. 9, it is assumed that the location of the reference device 920 on the three-dimensional plane is (0, 0, 0).

### First Operation

Referring to FIGS. 9A and 9B, the location of the user device 910 based on the location of the reference device 920 may be determined in the first operation.

In an embodiment, the first operation may be performed using UWB ranging between the user device 910 and the reference device 920. For example, the UWB two-way ranging (TWR) method illustrated in FIG. 4 may be used.

As a result of the UWB ranging, distance information (for example, ToF information) indicating the distance between the reference device 920 and the user device 910 and direction (angle) information (for example, angle of arrival (AoA) information including AoA azimuth (horizontal angle) and/or AoA elevation (vertical angle)) indicating an angle between the reference device 920 and the user device 910 may be acquired. For example, as illustrated in FIG. 9, through the UWB ranging, the distance (dᵣ₂ᵤ) between the reference device 920 and the user device 910 on the three-dimensional plane, the horizontal angle (AoA azimuth (θᵣ₂ᵤ)) between the reference device 920 and the user device 910, based on the reference device 920, and the vertical angle (AoA elevation (φᵣ₂ᵤθᵣ₂ᵤ)) between the reference device 920 and the user device 910, based on the reference device 920 may be acquired.

Based on the distance information and the direction information, the location (xᵤ,yᵤ,zᵤ) of the user device 910, based on the location of the reference device 920, may be determined. For example, the location of the user device 910 may be determined based on Equation 1 below.

$$\begin{matrix}{x}_{u} = {d}_{r 2 u} cos ( {φ}_{r 2 u} ) cos ( {θ}_{r 2 u} ) \\ {y}_{u} = {d}_{r 2 u} cos ( {φ}_{r 2 u} ) sin ( {θ}_{r 2 u} ) \\ {z}_{u} = {z}_{r} + {d}_{r 2 u} sin ( {φ}_{r 2 u} )\end{matrix} \qquad Equation 1$$

θᵣ₂ᵤ denotes a horizontal angle between the user device 910 and the reference device 920, based on the reference device 920. φᵣ₂ᵤ denotes a vertical angle between the user device 910 and the reference device 920, based on the reference device 920.

dᵣ₂ᵤ cos(φᵣ₂ᵤ) denotes a two-dimensional distance (horizontal distance) between the user device 910 and the reference device 920. This may be acquired by projecting a straight line corresponding to the three-dimensional distance dᵣ₂ᵤ to a two-dimensional plane (xy plane). It is illustrated as in FIG. 9B.

### Second Operation

Referring to FIGS. 9A and 9C, locations of at least two points of the target device 930, based on the location of the reference device 920, may be determined in the second operation.

As an embodiment, the second operation may include an operation (operation 2-1) of acquiring a slot of the user device 910 (for example, a slot against to the ground) pointing to at least two points of the target device 930. In the disclosure, the slot of the user device 910 pointing to a specific point of the target device may be expressed as φ_{g}. For example, a first slope of the user device 910 pointing to a first point 910 of the target device may be expressed as φ_{g1}, and a second slope of the user device 910 pointing to a second point 92 of the target device may be expressed as φ_{g2}.

As an embodiment, operation 2-1 may be performed using at least one sensor of the user device 910. For example, a (gravitational) acceleration sensor may be used to acquire a slot (for example, a slot against to the ground) of the user device 910 pointing to at least two points of the target device 930. For example, the user device 910 may acquire the first slope (φ_{g1}) of the user device 910 pointing to the first point 91 of the target device 930 and the second slope (φ_{g2}) of the user device 910 pointing to the second point 92 of the target device 930 through the acceleration sensor.

As an embodiment, the second operation may include an operation (operation 2-2) for determining the location of the target device 930, based on the location of the reference device 920, through the acquired slopes. For example, the user device 910 may determine the location of the first point 91 of the target device 930 by using the first slope (φ_{g1}) of the user device 910 and determine the location of the second point 92 of the target device 930 by using the second slope (φ_{g2}) of the user device 910.

As an embodiment, the user device 910 may determine the location of each point of the target device 930, based on Equation 2 below.

$$\begin{matrix}{λ}_{t} = {x}_{u} + cos ( {θ}_{u 2 t} + π ) \\ {y}_{t} = {y}_{u} + sin ( {θ}_{u 2 t} + π ) \\ {z}_{t} = {z}_{u} + d sin ( {φ}_{g} )\end{matrix} \qquad Equation 2$$

d sin(φ_{g}) denotes a two-dimensional distance (vertical distance) between the user device 910 and the target device 930. This may be acquired by projecting a guided straight line corresponding to the three-dimensional distance “d” between the user device 910 and the target device 930 to the two-dimensional plane (xz or yz plane), based on the slop φ_{g}. This is as illustrated in FIG. 9C.

θᵤ₂ₜ denotes a horizontal angle between the user device 910 and the target device 930, based on the user device 910. For example, θᵤ₂ₜ may be determined based on Equation 3 below.

$${θ}_{u 2 t} = ( \frac{π}{2} - {θ}_{u 2 r} ) + {θ}_{r 2 u} \qquad Equation 3$$

θᵤ₂ₜ denotes a horizontal angle between the user device 910 and the reference device 920, based on the user device 910, and θᵤ₂ₜ denotes a horizontal angle between the reference device 920 and the user device 910, based on the reference device 920.

As an embodiment, the second operation may include an operation (operation 2-3) for determining the size of the target device 930 or an area corresponding to the target device 930, based on the location of each point of the target device 930.

In an embodiment, when at least three locations are determined among an upper right corner, a lower left corner, or a lower right corner of the target device 930 through operation 2-1/2-2, the user device 910 may determine the size of the target device 930 or a three-dimensional area (plane) corresponding to the target device 930.

In another embodiment, when at least two locations are determined among an upper right corner, a lower left corner, or a lower right corner of the target device 930 through operation 2-1/2-2, the user device 910 may determine the size of the target device 930 or the three-dimensional area (plane) corresponding to the target device 930 by using at least one of the height or the width of the target device which has been already known or input by the user. For example, as illustrated in FIG. 9A, when the locations of the first point 91 corresponding to the lower right corner of the target device 930 and the second point 92 corresponding to the lower left corner are determined, the user device 910 may determine the size of the target device 930 or the three-dimensional plane corresponding to the target device 930 by using the height of the target device which has been already known or input by the user.

Meanwhile, in the embodiment of FIG. 9, as described above, the user device 910 is guided to be located at the predefined distance “d” for the registration procedure. In this case, since the user device 910 has difficulty in being located at the distance which is completely the same as the distance d, it may be difficult to detect the accurate location of the corresponding point of the target device. This may make a measurement error to generate an error in recognition of the target device 930.

FIG. 10 illustrates a second embodiment of the registration procedure of registering a UWB-disabled device according to an embodiment of the disclosure.

An embodiment of FIG. 10 illustrates an example of the registration procedure according to the second option of the registration procedure illustrated in FIG. 7B.

In the embodiment of FIG. 10, it is assumed that a user device 1010 provides a guide (user guide) to the user to point to at least two points of a target device 1030 at each of at least two locations.

The registration procedure of FIG. 10 may include an operation (first operation) of identifying the location of the user device 1010, based on the location of a reference device 1020, and an operation (second operation) of identifying the location and/or the size of the target device 1030, based on the location of the reference device 1020.

Through the registration procedure, the location and/or the size of the target device 1030 relative to the location (reference location) of the reference device 1020 may be identified. The identified location and/or size of the target device 1030 may be stored and used for the recognition procedure performed thereafter.

In the embodiment of FIG. 10, it is assumed that the location of the reference device 1020 on the three-dimensional plane is (0, 0, 0).

### First Operation

In the first operation, each location of the user device 1010 based on the location of the reference device 1020 is determined. For example, the user device 1010 may acquire a first location (α₁) of the user device 1010 and a second location (α₂) of the user device 1010, based on the location of the reference device 1020.

In an embodiment, the first operation may be performed using UWB ranging between the user device 1010 and the reference device 1020. For example, the UWB two-way ranging (TWR) method illustrated in FIG. 4 may be used.

As a result of the UWB ranging, distance information (for example, ToF information) indicating the distance between the reference device 1020 and the user device 1010 and direction (angle) information (for example, angle of arrival (AoA) information including AoA azimuth (horizontal angle) and/or AoA elevation (vertical angle)) indicating an angle between the reference device 1020 and the user device 1010 may be acquired. For example, through the UWB ranging, the distance between the reference device 1020 and the user device 1010 on the three-dimensional plane, the horizontal angle (AoA azimuth) between the reference device 20 and the user device 1010, based on the reference device 1020, and the vertical angle (AoA elevation) between the reference device 1020 and the user device 1010, based on the reference device 1020, may be acquired.

As a result of ranging at each location, a first location (α₁) of the user device 1010 and a second location (α₂) of the user device 1010, based on the location of the reference device 1020 may be acquired as illustrated in FIG. 10A. For example, each location of the user device 1010 may be determined based on Equation 1 above.

### Second Operation

In the second operation, locations of at least two points of the target device 1030, based on the location of the reference device 1020, may be determined.

As an embodiment, the second operation may include an operation (operation 2-1) of acquiring the horizontal angle between two points of the target device 1030, the vertical angle therebetween, and/or the distance between the user device 1010 and the target device 1030 through the operation of the user device 1010 of pointing to (scanning) the two points of the target device 1030 at a specific location. In the disclosure, the scanning operation may be an operation of moving the user device 1010 from one point of the target device 1030 to another point in an indicated direction (for example, a straight line direction).

For example, as illustrated in FIG. 10A, through an operation in which the user device 1010 scans for (or point to) a first point (P₁) 11 corresponding to the lower right corner of the target device 1030 and a second point (P₂) 12 corresponding to the lower left corner of the target device 1030 at the first location (α₁), a first horizontal angle (θ₁) between the first point (P₁) 11 and the second point (P₂) 12 may be acquired. Further, through an operation in which the user device 1010 scans for (or point to) the first point (P₁) 11 corresponding to the lower right corner of the target device 1030 and a third point (P₃) 13 corresponding to the upper right corner of the target device 1030 at the first location (α₁), a first vertical angle (φ₁) between the first point (P₁) 11 and the third point (P₃) 13 may be acquired. The user device 1010 may acquire a distance (L₁) between the first location (α₁) of the user device 1010 and the target device 1030. As an embodiment, the distance (L₁) may be a distance between the first location (α₁) of the user device 1010 and the first point (P₁) 11. That is, the distance may be a shortest distance between the first location (α₁) of the user device 1010 and the target device 1030.

In another example, as illustrated in FIG. 10A, through an operation in which the user device 1010 scans for (or point to) the first point (P₁) 11 corresponding to the lower right corner of the target device 1030 and the second point (P₂) 12 corresponding to the lower left corner of the target device 1030 at the second location (α₂), a second horizontal angle (θ₂) between the first point (P₁) 11 and the second point (P₂) 12 may be acquired. Further, through an operation in which the user device 1010 scans for (or point to) the first (P₁) 11 corresponding to the lower right corner of the target device 1030 and a third point (P₃) 13 corresponding to the upper right corner of the target device 1030 at the second location (α₂), a second vertical angle (φ₂) between the first point (P₁) 11 and the third point (P₃) 13 may be acquired. The user device 1010 may acquire a distance (L₂) between the second location (α₂) of the user device 1010 and the target device 1030. As an embodiment, the distance (L₁) may be a distance between the second location (α₂) of the user device 1010 and the second point (P₂) 12. That is, the distance may be a shortest distance between the second location (α₂) of the user device 1010 and the target device 1030.

As an embodiment, a horizontal angle between two points of the target device 1030 may be acquired based on an AoA azimuth (UWB azimuth AoA) value acquired through UWB ranging and/or a double integral value of acceleration.

As an embodiment, a vertical angle between two points of the target device 1030 may be acquired based on an AoA elevation (UWB elevation AoA) value acquired through UWB ranging, a double integral value of acceleration, and/or a value of (gravitational) acceleration.

As an embodiment, the second operation may include an operation (operation 2-2) of determining the location of a specific point of the target device 1030 on the xy plane by projecting straight lines pointing to the specific point of the target device 1030 at different locations and calculating an intersection point on the xy plane between the straight lines. For example, as illustrated in FIG. 10B, the user device 1010 may determine the location of the first point (P₁) 11 on the xy plane by projecting a straight line pointing to the first point (P₁) 11 at the first location (α₁) and a straight line pointing to the first point (P₁) 11 at the second location (α₂) to the xy plane and calculating the intersection point on the xy plane between the two straight lines. In addition, the user device 1010 may determine the location of the second point (P₂) 120 on the xy plane by projecting a straight line pointing to the second point (P₂) 12 at the first location (α₁) and a straight line pointing to the second point (P₂) 12 at the second location (α₂) to the xy plane and calculating the intersection point on the xy plane between the two straight lines.

As an embodiment, the user device 1010 may calculate the intersection point between two straight lines by using the first horizontal angle (θ₁) and the first distance (L₁) at the first location (α₁) and the second horizontal angle (θ₂) and the second distance (L₂) at the second location (α₂).

As an embodiment, the second operation may include an operation (operation 2-3) of determining the location of a specific point of the target device 1030 on the xy plane or the yz plane by projecting the location of the specific point of the target device 1030 on the xy plane determined through operation 2-2 to the xz plane or the yz plane at one location. For example, as illustrated in FIG. 10C, the user device 1010 may determine the location of a third point (P₃) 13 from the location of the first point (P₁) 11 by using the first vertical angle (φ₁) at the first location (α₁). In another example, the user device 1010 may determine the location of the third point (P₃) 13 from the location of the first point (P₁) 11 by using the second vertical angle (φ₁) at the second location (α₂).

Through the first operation and the second operation, the user device 1010 may determine locations of at least two points (or three points) of the target device 1030 based on the reference device 1020. Further, the user device 1010 may determine the size of the target device 1030 or one three-dimensional plane corresponding to the target device 1030 through the determined locations of the points of the target device 1030. As an embodiment, the user device 1010 may determine the three-dimensional plane corresponding to the target device 1030 through Equation 4 below.

$$\begin{matrix}A = y 1 ( z 2 - z 3 ) + y 2 ( z 3 - z 1 ) + y 3 ( z 1 - z 2 ) \\ B = z 1 ( x 2 - x 3 ) + z 2 ( x 3 - x 1 ) + z 3 ( x 1 - x 2 ) \\ C = x 1 ( y 2 - y 3 ) + x 2 ( y 3 - y 1 ) + x 3 ( y 1 - y 2 ) \\ - D = x 1 ( y 2 z 3 - y 3 z 2 ) + x 2 ( y 3 z 1 - y 1 z 3 ) + x 3 ( y 1 z 2 - y 2 z 1 )\end{matrix} \qquad Equation 4$$

(x₁,y₁,z₁) corresponds to coordinates of the first point (P₁) 11, (x₂,y₂,z₂) corresponds to coordinates of the second point (P₂) 12, and (x₃,y₃,z₃) corresponds to coordinates of the third point (P₃) 13.

When there are a plurality of target devices 1030, the user device 1010 may determine each three-dimensional plane corresponding to each target device 1030 through Equation 4.

The specified size of the target device 1030 or one three-dimensional plane corresponding to the target device 1030 may be used for an operation of recognizing the target device 1030.

FIG. 11 illustrates a method by which a user device recognizes a target device according to an embodiment of the disclosure.

An embodiment of FIG. 11 illustrates an example of the recognition procedure of FIG. 8.

Referring to FIG. 11, a user device 1110 may recognize a target device 1130, based on an intersection point 10 between a straight line to which the user device 1110 points and a three-dimensional plane corresponding to the target device 1130.

As an embodiment, the user device 1110 may identify whether there is the intersection point 10 between the straight line to which the user device 1110 points and the three-dimensional plane corresponding to the target device 1130 by using a plane equation determined using Equation 4.

Meanwhile, when there are a plurality of target devices 1130, three-dimensional planes corresponding to the plurality of target devices 1130 may exist. In this case, the straight line to which the user device 1110 points may have intersection points with the three-dimensional planes of the plurality of target devices 1130. Accordingly, there are a plurality of intersection points, it is required to select the target device 1130 which the user desires to actually control. To this end, the user device 1110 may provide the user with UX/UI information for selecting the target device 1130 which the user desires to control. For example, the user device 1110 may list the target devices 1130 corresponding to the intersection points identified in the order of distance closer to the user device 1110 and provide the listed target devices to the user. In this case, the user may select the target device 1130 which the user desires to control based on the information.

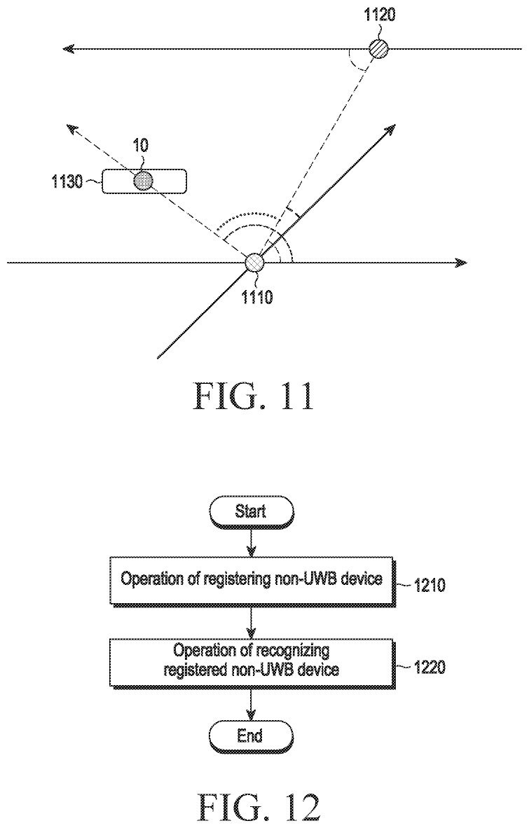

FIG. 12 is a flowchart illustrating a method of a first UWB device according to an embodiment of the disclosure.

In an embodiment of FIG. 12, the first UWB device may correspond to the user device, a second UWB device may correspond to the reference device, and a non-UWB device may correspond to the target device.

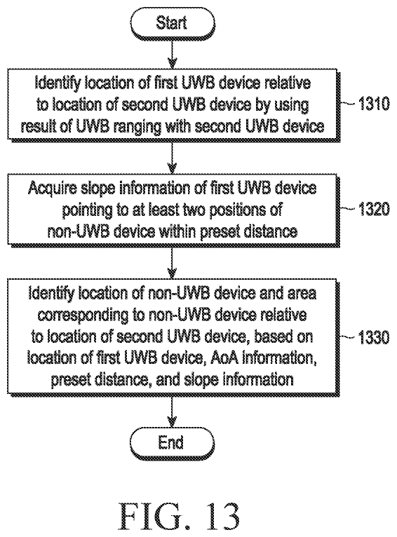

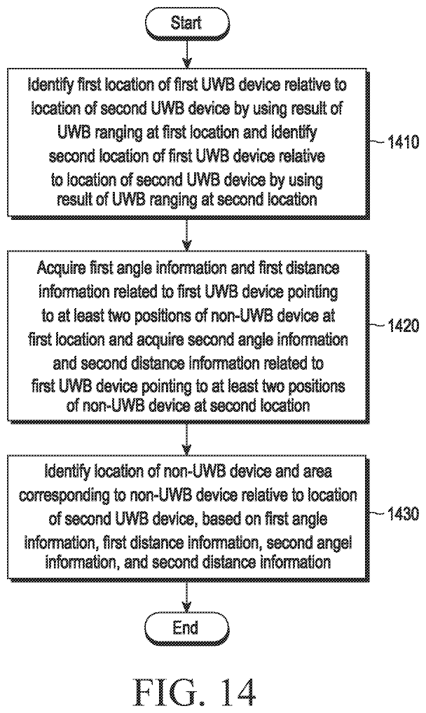

Referring to FIG. 12, the first UWB device may perform a registration operation of the non-UWB device in operation 1210. In an embodiment, the registration operation may include an operation of identifying a location of the non-UWB device and/or an area corresponding to the non-UWB device, relative to the location of the second UWB device, based on UWB ranging between the first UWB device and the second UWB device. For the registration, refer to the description made with reference to FIGS. 7, 9, and 10 and description made with reference to FIGS. 13 and 14 below.

The first UWB device may perform a recognition operation of the registered non-UWB device in operation 1120. In an embodiment, the recognition operation may include an operation of identifying whether the first UWB device points to the registered non-UWB device, based on a direction to which the first UWB device points and the location of the non-UWB device and/or the area corresponding to the non-UWB device identified in the registration operation. For the recognition operation, refer to the description made with reference to FIGS. 8 and 11.

FIG. 13 is a flowchart illustrating a registration operation of the first UWB device according to an embodiment of the disclosure.

The registration operation of FIG. 13 may be an embodiment following the first option of the registration operation described with reference to FIGS. 7A and 9. Accordingly, for the registration operation of FIG. 12, refer to the description of FIGS. 7A and 9.

In an embodiment of FIG. 13, the first UWB device may correspond to the user device, a second UWB device may correspond to the reference device, and a non-UWB device may correspond to the target device.

Referring to FIG. 13, the first UWB device may identify the location of the first UWB device, based on the location of the second UWB device, by using a result of UWB ranging with the second UWB device in operation 1310. In an embodiment, the UWB ranging may be performed based on a two-way ranging (TWR) method. In an embodiment, the result of the UWB ranging may include time of flight (ToF) information and angle of arrival (AoA) information (angle information). As an embodiment, the AoA information may include AoA azimuth information (horizontal angle information) and/or AoA elevation information (vertical angle information). Identification of the location of the first UWB device relative to the location of the second UWB device may be based on Equation 1.

The first UWB device may acquire slope information of the first UWB device pointing to at least two points of the non-UWB device within a preset distance in operation 1320. For example, the first UWB device may acquire slope information of the first UWB device pointing to two vertices or three vertices of the non-UWB device within a preset distance.

The first UWB device may identify the location of the non-UWB device and the area corresponding to the non-UWB device, relative to the location of the second UWB device, based on the location of the first UWB device, AoA information, a preset distance, and/or slope information in operation 1330. Identification of the location of the non-UWB device relative to the location of the second UWB device may be based on Equation 2 and Equation 3. Identification of the area of the non-UWB device may be based on Equation 4.

FIG. 14 is a flowchart illustrating the registration operation of the first UWB device according to another embodiment of the disclosure.

The registration operation of FIG. 14 may be an embodiment following the second option of the registration operation of FIGS. 7B and 10. Accordingly, refer to the description of FIGS. 7B and 10 for the registration operation of FIG. 14.

In an embodiment of FIG. 14, the first UWB device may correspond to the user device, a second UWB device may correspond to the reference device, and a non-UWB device may correspond to the target device.

Referring to FIG. 14, the first UWB device may identify a first location of the first UWB device relative to the location of the second UWB device by using the result of UWB ranging with the second UWB device at the first location and identify a second location of the first UWB device relative to the location of the second UWB device by using the result of UWB ranging with the second UWB device at the second location in operation 1410. In an embodiment, the result of UWB ranging at the first location may include ToF information (distance information) for the first location and AoA information (angle information) including AoA azimuth information (horizontal angle information) and/or AoA elevation information (vertical angle information), and the result of UWB ranging at the second location may include ToF information (distance information) for the second location and AoA information (angle information) including AoA azimuth information (horizontal angle information) and/or AoA elevation information (vertical angle information). Identification of each of the first location and the second location of the first electronic device relative to the location of the second UWB device may be based on Equation 1.

The first UWB device may acquire first angle information and first distance information related to the first UWB device pointing to at least two points of the non-UWB device at the first location and acquire second angle information and second distance information related to the first UWB device pointing to at least two points of the non-UWB device at the second location in operation 1420.

As an embodiment, the first angle information may include first horizontal angle information (AoA azimuth information) for a horizontal angle between the first point and the second point of the non-UWB device to which the first UWB device at the first location points and/or first vertical angle information (AoA elevation information) for a vertical angle between the first point and the third point of the non-UWB device to which the first UWB device at the first location points. As an embodiment, the second angle information may include second horizontal angle information for a horizontal angle between the first point and the second point of the non-UWB device to which the first UWB device at the second location points and/or second vertical angle information for a vertical angle between the first point and the third point of the non-UWB device to which the first UWB device at the second location points.

As an embodiment, the first distance information may include first distance information for a distance between the first UWB device at the first location and the first point of the non-UWB device. As an embodiment, the second distance information may include second distance information for a distance between the first UWB device at the second location and the second point of the non-UWB device.

The first UWB device may identify the location of the non-UWB device and the area corresponding to the non-UWB device relative to the location of the second UWB device, based on the first angle information, the first distance information, the second angle information, and the second distance information in operation 1430.

As an embodiment, the first UWB device may identify the locations of the first point and the second point of the non-UWB device on the xy plane, based on the first horizontal angle information, the first distance information, the second horizontal angle information, and/or the second distance information. For example, the first UWB device may identify the location of the first point of the non-UWB device relative to the location of the second UWB device by acquiring the intersection point on the xy plane between a first straight line pointing to the first point of the non-UWB device at the first location and a second straight line pointing to the first point of the non-UWB device at the second location, based on the first horizontal angle information, the first distance information, the second horizontal angle information, and/or the second distance information. Further, the first UWB device may identify the location of the second point of the non-UWB device relative to the location of the second UWB device by acquiring the intersection point on the xy plane between a third straight line pointing to the second point of the non-UWB device at the first location and a fourth straight line pointing to the second point of the non-UWB device at the second location, based on the first horizontal angle information, the first distance information, the second horizontal angle information, and/or the second distance information.

As an embodiment, the first UWB device may identify the location of the third point of the non-UWB device, based on at least one of the first vertical angle information or the second vertical angle information.

As an embodiment, the first UWB device may identify the area corresponding to the non-UWB device, based on the identified locations of the first point, the second point, and the third point.

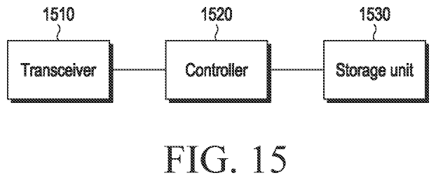

FIG. 15 illustrates a structure of the electronic device according to an embodiment of the disclosure.

In an embodiment of FIG. 15, the electronic device may be a UWB device (for example, the user device (first UWB device) or the reference device (second UWB device)) or a non-UWB device (for example, the target device).

Referring to FIG. 15, the electronic device may include a transceiver 1510, a controller 1520, and a storage unit 1530. In the disclosure, the controller may be defined as a circuit, an application-specific integrated circuit, or at least one processor.

The transceiver 1510 may transmit/receive a signal to/from another network entity. The transceiver 1510 may transmit and receive data for UWB ranging through, for example, UWB communication.

The controller 1520 may control the overall operation of the electronic device according to an embodiment proposed in the disclosure. For example, the controller 1520 may control a signal flow between blocks to perform the operation according to the above-described flowchart. Specifically, the controller 1520 may control, for example, the operation of the electronic device described with reference to FIGS. 1 to 14.

The storage unit 1530 may store at least one piece of information transmitted/received through the transceiver 1510 and information generated through the controller 1520. For example, the storage unit 1530 may store, for example, information and data required for registering and recognizing the non-UWB device through the UWB described with reference to FIGS. 1 to 14.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

1. A method by a first ultra wide band (UWB) device, the method comprising:
registering a non-UWB device, based on UWB ranging between the first UWB device and a second UWB device; and
recognizing the registered non-UWB device, based on a direction to which the first UWB device points.

2. The method of claim 1, wherein registering the non-UWB device comprises:
identifying a location of the first UWB device relative to a location of the second UWB device, based on a result of the UWB ranging between the first UWB device and the second UWB device, and
wherein the result of the UWB ranging comprises time of flight (ToF) information and angle of arrival (AoA) information.

3. The method of claim 2, wherein registering the non-UWB device further comprises:
acquiring slope information of the first UWB device pointing to at least two points of the non-UWB device within a preset distance; and
identifying a location of the non-UWB device and an area corresponding to the non-UWB device relative to a location of the second UWB device, based on the location of the first UWB device, the AoA information, the preset distance, and the slope information.

4. The method of claim 1, wherein registering the non-UWB device comprises:
identifying a first location of the first UWB device relative to a location of the second UWB device by using a result of first UWB ranging with the second UWB device at the first location; and
identifying a second location of the first UWB device relative to the location of the second UWB device by using a result of second UWB ranging with the second UWB device at the second location, and
wherein the result of the first UWB ranging comprises first ToF information and first AoA information for the first location, and the result of the second UWB ranging comprises second ToF information and second AoA information for the second location.

5. The method of claim 4, wherein registering the non-UWB device further comprises:
acquiring first angle information and first distance information related to the first UWB device pointing to at least two points of the non-UWB device at the first location, and
acquiring second angle information and second distance information related to the first UWB device pointing to at least two points of the non-UWB device at the second location,
wherein the first angle information comprises first horizontal angle information for a horizontal angle between a first point and a second point of the non-UWB device to which the first UWB device at the first location points, and first vertical angle information for a vertical angle between the first point and a third point of the non-UWB device to which the first UWB device at the first location points, and
wherein the second angle information comprises second horizontal angle information for a horizontal angle between the first point and the second point of the non-UWB device to which the first UWB device at the second location points.

6. The method of claim 5, wherein registering the non-UWB device further comprises:
identifying a location of the first point of the non-UWB device relative to the location of the second UWB device, by acquiring an intersection point on an xy plane between a first straight line pointing to the first point of the non-UWB device at the first location and a second straight line pointing to the first point of the non-UWB device at the second location, based on at least one piece of the first horizontal angle information, the first distance information, the second horizontal angle information, or the second distance information;
identifying a location of the second point of the non-UWB device relative to the location of the second UWB device, by acquiring an intersection point on an xy plane between a third straight line pointing to the second point of the non-UWB device at the first location and a fourth straight line pointing to the second point of the non-UWB device at the second location, based on at least one piece of the first horizontal angle information, the first distance information, the second horizontal angle information, or the second distance information; and
identifying a location of the third point of the non-UWB device relative to the location of the second UWB device, based on the first vertical angle information.

7. The method of claim 6, wherein registering the non-UWB device further comprises:
identifying an area corresponding to the non-UWB device, based on the locations of the first point, the second point, and the third point.

8. The method of claim 1, wherein the UWB ranging is performed based on a two-way ranging (TWR) scheme.

9. A first ultra wide band (UWB) device comprising:
a transceiver; and
a controller connected to the transceiver,
wherein the controller is configured to:
register a non-UWB device, based on UWB ranging between the first UWB device and a second UWB device; and
recognize the registered non-UWB device, based on a direction to which the first UWB device points.

10. The first UWB device of claim 9,
wherein the controller is further configured to identify a location of the first UWB device relative to a location of the second UWB device, based on a result of the UWB ranging between the first UWB device and the second UWB device, and
wherein the result of the UWB ranging comprises time of flight (ToF) information and angle of arrival (AoA) information.

11. The first UWB device of claim 10, wherein the controller is further configured to:
acquire slope information of the first UWB device pointing to at least two points of the non-UWB device within a preset distance; and
identify a location of the non-UWB device and an area corresponding to the non-UWB device relative to a location of the second UWB device, based on the location of the first UWB device, the AoA information, the preset distance, and the slope information.

12. The first UWB device of claim 9,
wherein the controller is further configured to:
identify a first location of the first UWB device relative to a location of the second UWB device by using a result of first UWB ranging with the second UWB device at the first location; and
identify a second location of the first UWB device relative to the location of the second UWB device by using a result of second UWB ranging with the second UWB device at the second location, and
wherein the result of the first UWB ranging comprises first ToF information and first AoA information for the first location, and the result of the second UWB ranging comprises second ToF information and second AoA information for the second location.

13. The first UWB device of claim 12,
wherein the controller is further configured to:
acquire first angle information and first distance information related to the first UWB device pointing to at least two points of the non-UWB device at the first location, and
acquire second angle information and second distance information related to the first UWB device pointing to at least two points of the non-UWB device at the second location,
wherein the first angle information comprises first horizontal angle information for a horizontal angle between a first point and a second point of the non-UWB device to which the first UWB device at the first location points and first vertical angle information for a vertical angle between the first point and a third point of the non-UWB device to which the first UWB device at the first location points, and
wherein the second angle information comprises second horizontal angle information for a horizontal angle between the first point and the second point of the non-UWB device to which the first UWB device at the second location points.

14. The first UWB device of claim 13, wherein the controller is further configured to:
identify a location of the first point of the non-UWB device relative to the location of the second UWB device by acquiring an intersection point on an xy plane between a first straight line pointing to the first point of the non-UWB device at the first location and a second straight line pointing to the first point of the non-UWB device at the second location, based on at least one piece of the first horizontal angle information, the first distance information, the second horizontal angle information, or the second distance information;
identify a location of the second point of the non-UWB device relative to the location of the second UWB device by acquiring an intersection point on an xy plane between a third straight line pointing to the second point of the non-UWB device at the first location and a fourth straight line pointing to the second point of the non-UWB device at the second location, based on at least one piece of the first angle information, the first distance information, the second angle information, or the second distance information; and
identify a location of the third point of the non-UWB device relative to the location of the second UWB device, based on the first vertical angle information.

15. The first UWB device of claim 14, wherein the controller is further configured to identify an area corresponding to the non-UWB device, based on the locations of the first point, the second point, and the third point.
